(19) United States
(12) Patent Application Publication
(10) Pub. No.: US 2017/0315757 A1
(43) Pub. Date: Nov. 2, 2017

(54) PROCESSOR AND INFORMATION PROCESSING METHOD

(71) Applicant: Lenovo (Beijing) Co., Ltd., Beijing (CN)

(72) Inventor: Haiyang HE, Beijing (CN)

(21) Appl. No.: 15/458,418

(22) Filed: Mar. 14, 2017

(30) Foreign Application Priority Data
Apr. 27, 2016 (CN) 201610274074.3

(51) Int. Cl. G06F 3/06

(52) U.S. Cl. CPC G06F 3/0689; G06F 3/0613; G06F 3/0659

(57) ABSTRACT

An information processing method is provided for a processor connected to a plurality of non-volatile memory modules and having a core and an uncore. The information processing method includes receiving, by the processor, data to be stored and an identification of a target storage unit; determining, by the processor, a target storage space from at least one of the plurality of non-volatile memory modules for storing the data; and storing, by the processor, the data in the target storage space, and establishing an address mapping relationship between the identification of the target storage unit as received and the target storage space as determined.

### CROSS-REFERENCES TO RELATED APPLICATIONS

This application claims priority of Chinese Patent Application No. 201610274074.3, filed on Apr. 27, 2016, the entire contents of which are hereby incorporated by reference.

### FIELD OF THE INVENTION

The present disclosure generally relates to the field of processor technology and, more particularly, relates to a processor and an information processing method thereof.

### BACKGROUND

Intel® introduced a new type of non-volatile memory module. This new type of non-volatile memory module includes a volatile memory and a persistent memory, such as an AEP DIMM.

When a processor is connected to an external non-volatile memory module, the computing core (or simply core) of the processor perform data exchange with the non-volatile memory module through the built-in memory controller (IMC). However, when the processor is connected with multiple external non-volatile memory modules, each non-volatile memory module is considered as an independent storage device with respect to the processor's core, which may complicated the data processing of the processor's core. Further, it may also be difficult for the independent storage device to implement RAID0/1/5 or similar functionalities.

The disclosed processor and information processing method thereof are directed to solve one or more problems set forth above and other problems.

### BRIEF SUMMARY OF THE DISCLOSURE

A first aspect of the present disclosure is an information processing method, comprising: receiving, by a processor connected to a plurality of non-volatile memory modules, data to be stored and an identification of a target storage unit; determining, by the processor, a target storage space from at least one of the plurality of non-volatile memory modules for storing the data; and storing, by the processor, the data in the target storage space, and establishing an address mapping relationship between the identification of the target storage unit as received and the target storage space as determined.

A second aspect of the present disclosure is a processor, comprising: a core for executing instructions; and a first controller coupled to the core and a plurality of non-volatile memory modules, wherein the first controller is configured to: receive data to be stored and an identification of a target storage unit; determine a target storage space from at least one of the plurality of non-volatile memory modules for storing the data; and store the data in the target storage space, and establish an address mapping relationship between the identification of the target storage unit as received and the target storage space as determined.

Other aspects of the present disclosure can be understood by those skilled in the art in light of the description, the claims, and the drawings of the present disclosure.

### BRIEF DESCRIPTION OF THE DRAWINGS

The following drawings are merely examples for illustrative purposes according to various disclosed embodiments and are not intended to limit the scope of the present disclosure.

FIG. 1 illustrates a flow chart of an exemplary information processing method consistent with the disclosed embodiments;

FIG. 2 illustrates a structural diagram of an exemplary processor consistent with disclosed embodiments;

FIG. 3 illustrates a structural diagram of another exemplary processor consistent with disclosed embodiments;

FIG. 4 illustrates a structural diagram of another exemplary processor consistent with disclosed embodiments; and

FIG. 5 illustrates a structural diagram of another exemplary processor consistent with disclosed embodiments.

### DETAILED DESCRIPTION

Reference will now be made in detail to exemplary embodiments of the invention, which are illustrated in the accompanying drawings. Wherever possible, the same reference numbers will be used throughout the drawings to refer to the same or like parts. The described embodiments are some but not all of the embodiments of the present invention. Based on the disclosed embodiments and without inventive efforts, persons of ordinary skill in the art may derive other embodiments consistent with the present disclosure, all of which are within the scope of the present invention.

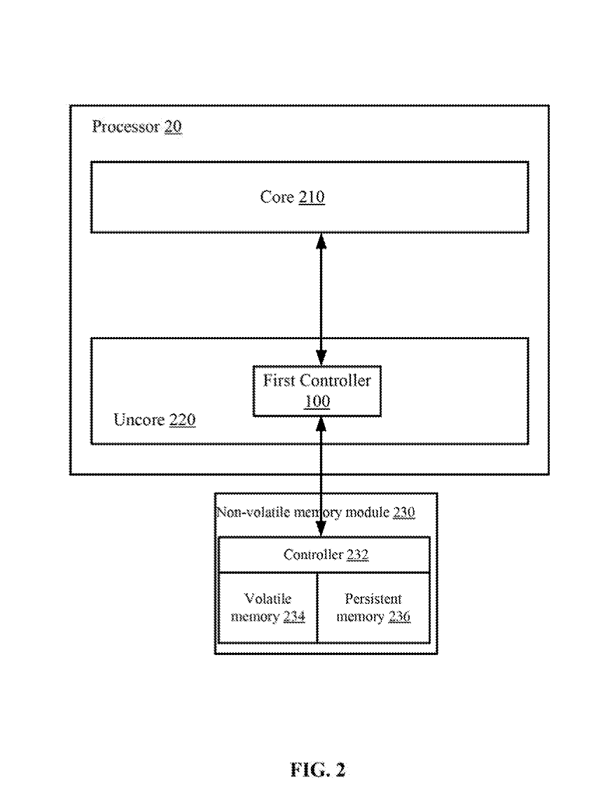

FIG. 2 illustrates a structural diagram of an exemplary processor consistent with disclosed embodiments. As shown in FIG. 2, a processor 20 may include a computing core (or simply core) 210 and an uncore 220. The core 210 may contain components of the processor involved in executing instructions, including arithmetic and logical unit (ALU), floating point unit (FPU), L1 and L2 cache, etc. The uncore 220 may refer to functions of a microprocessor that are not in the core, but need to be on the same silicon die as the core and closely connected to the core to achieve high performance, also called system agent, such as L3 cache and on-die memory controller, etc.

The processor 20 is connected to a plurality of external non-volatile memory modules (or banks) 230, each of which may include a volatile memory 234, a persistent memory 236, and a controller 232. The uncore 220 may include a first controller 100, and the first controller 100 is connected to the plurality of external non-volatile memory modules 230. The processor 20 is connected to the non-volatile memory modules 230 through the first controller 100.

The first controller 100 may partition the non-volatile memory modules 230 into at least one storage unit, and each storage unit includes a plurality of persistent memories of the non-volatile memory modules. The core 210 may store first-type data to the storage unit through the first controller 100. As used herein, the first-type data may refer to data that needs to be stored in a non-volatile storage medium, while the second-type data may refer to data that can be stored in a volatile storage medium.

More specifically, the first controller 100 may receive from the core 210 the first-type data to be stored and the identification of the target storage unit. Based on the partition structure of the persistent memories of the plurality of non-volatile memory modules and the identification of the target storage unit, the first controller 100 may determine a target storage space in the persistent memories of the plurality of non-volatile memory modules for the first-type data to be stored. Further, the first controller 100 may store the to-be-stored first-type data in the target storage space, and also store an address mapping relationship between the data identification of the first-type data and the target storage space.

Further, the first controller 100 may receive from the core 210 an instruction containing a data read request to read the first-type data, and the data read request includes an identification of the data to be read. Based on the identification of the data to be read and the stored address mapping relationship between the data identification of the first-type data and the target storage space, the first controller 100 determines a first storage space storing the data to be read, reads the data in the first storage space, and sends the read-back data to the core 210 of the processor 20.

Thus, according to a disclosed embodiment, the processor 20 has the first controller 100 disposed in the uncore 220 of the processor 20, and the uncore 220 partitions the persistent memories of the plurality of non-volatile memory modules 230 into at least one storage unit. When the core 210 of the processor 20 stores the first-type data, the core 210 may only need to send to the first controller 100 with the first-type data to be stored and the identification of the target storage unit, and the first controller 100 can store the to-be-stored first-type data in the persistent memory of one or more non-volatile memory modules 230.

When the core 210 of the processor 20 reads the first-type data, the core 210 may only need to send to the first controller 100 with a data read request having the identification of the data to be read, and the first controller 100 can read the to-be-read data from the persistent memory of the non-volatile memory modules 230 and send the read-back data to the core 210 of the processor 20. Accordingly, the core 210 of the processor 20 does not need to directly manage the persistent memories of the plurality of external non-volatile memory modules 230, simplifying the data processing of the core 210.

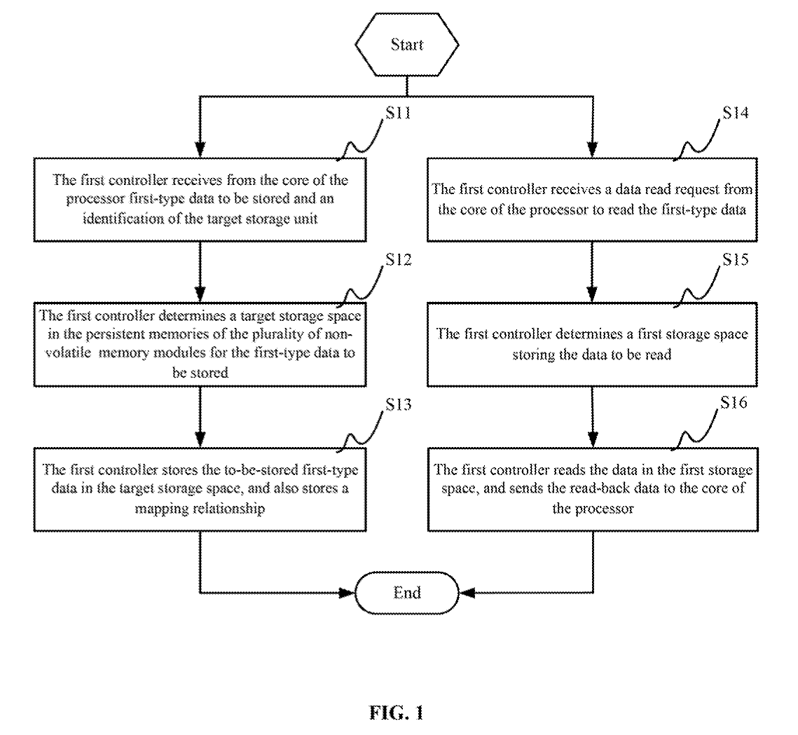

FIG. 1 illustrates a flowchart of an exemplary information processing method consistent with the disclosed embodiments. The information processing method may be performed by a processor having a core and an uncore. The processor is connected to a plurality of external non-volatile memory modules, each having a volatile memory and a persistent memory. The uncore of the processor includes a first controller, and the first controller partitions the persistent memories of the plurality of non-volatile memory modules into at least one storage unit. Each storage unit includes multiple persistent memories of the non-volatile memory modules. As shown in FIG. 1, the information processing method may include the followings.

S11: The first controller receives from the core of the processor first-type data to be stored and an identification of the target storage unit.

S12: Based on the partition structure of the persistent memories of the plurality of non-volatile memory modules and the identification of the target storage unit, the first controller determines a target storage space in the persistent memories of the plurality of non-volatile memory modules for the first-type data to be stored.

S13: The first controller stores the to-be-stored first-type data in the target storage space, and also stores an address mapping relationship between the data identification of the first-type data and the target storage space.

More specifically, the first controller partitions the persistent memories of the plurality of non-volatile memory modules into at least one storage unit, and each storage unit includes persistent memories of the multiple non-volatile memory modules. For example, the processor may be connected to a total of 16 external non-volatile memory modules, and each non-volatile memory module may have a persistent memory with 1G storage space. The first controller may partition the persistent memories of the 16 non-volatile memory modules into 4 storage units, each having 4G storage space. Alternatively, the first controller may partition the persistent memories of the 16 non-volatile memory modules into 2 storage units, each having 8G storage space. The first controller may also partition the persistent memories of the 16 non-volatile memory modules into 2 storage units of 4G storage space each plus 1 storage unit of 80G storage space. Other partitioning ways may also be used. When the first controller partitions the persistent memories of the plurality of non-volatile memory modules into at least one storage unit, the partitioning may be logical instead of physical.

After such partitioning, for the core of the processor, the plurality of storage units partitioned by the first controller are visible, while the persistent memories of the non-volatile memory modules are invisible. As used herein, the term “visible” refers to that, when the core of the processor stores the first-type data, the core of the processor uses the storage units partitioned by the first controller as a destination address. Similarly, the term “invisible” refers to that, when the core of the processor stores the first-type data, the core of the processor does not use the persistent memories of the non-volatile memory modules as the destination address.

Further, the first-type data may refer to data that needs to be stored in a non-volatile storage medium, and the second-type data may refer to data that can be stored in a volatile storage medium, such as internal memory data.

To store the first-type data, the core of the processor sends to the first controller the identification of the target storage unit and the first-type data to be stored. That is, to store the first-type data, the core of the processor only needs to determine which storage unit to store the first-type data is to be stored, without the need to consider which persistent memory of which non-volatile memory module is used to store the first-type data. The core of the processor does not need to directly manage the persistent memories of the plurality external non-volatile memory modules, thus simplifying the data processing of the processor core.

After the first controller receives from the core of the processor the identification of the target storage unit and the first-type data to be stored, and based on the partition structure of the persistent memories of the plurality of non-volatile memory modules and the identification of the target storage unit, the first controller can determine a target storage space in the persistent memories of the plurality of non-volatile memory modules for the first-type data to be stored. Further, the first controller may store the to-be-stored first-type data in the target storage space, and also store the address mapping relationship between the data identification of the first-type data and the target storage space, so as to respond to subsequent data read requests from the processor core to read the stored data.

S14: The first controller receives from the core of the processor an instruction containing a data read request to read the first-type data, and the data read request includes an identification of the data to be read.

S15: Based on the identification of the data to be read and the stored address mapping relationship between the data identification of the first-type data and the target storage space, the first controller determines a first storage space storing the data to be read.

S16: The first controller reads the data in the first storage space, and sends the read-back data to the core of the processor.

More specifically, when the core of the processor reads the first-type data, the core sends a data read request to the first controller, and the request carries an identification of the data to be read. The first controller has the stored address mapping relationship for the first-type data and, based on the identification of the data to be read and the stored address mapping relationship, determines the first storage space storing the data to be read. Further, the first controller reads the data in the first storage space, and sends the read-back data to the core of the processor.

Thus, according to disclosed embodiments, an information processing method is provided for a processor having a core and an uncore. The uncore of the processor includes a first controller, and the first controller partitions the persistent memories of the plurality of non-volatile memory modules into at least one storage unit. Each storage unit includes multiple persistent memories of the non-volatile memory modules. To store the first-type data, the core of the processor only needs to send to the first controller with the first-type data to be stored and the identification of the target storage unit, and the first controller stores the first-type data to be stored in the persistent memories of one or more non-volatile memory modules.

For the core of the processor to read the first-type data, the core only needs to send a data read request containing an identification of the data to be read to the first controller. The first controller reads out the data-to-be-read from the persistent memories of the non-volatile memory modules, and sends the read-back data to the core of the processor. Thus, the core of the processor does not need to directly manage persistent memories of the plurality external non-volatile memory modules, simplifying the data processing of the processor core.

In certain embodiments, the first controller may be a persistent memory manager (PMM).

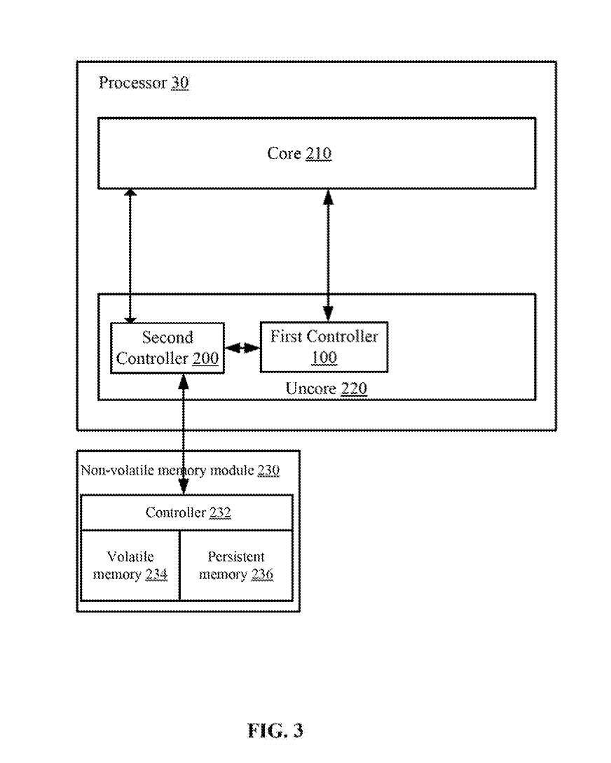

FIG. 3 illustrates a structural diagram of another exemplary processor 30 consistent with disclosed embodiments. Processor 30 as shown in FIG. 3 may be based on processor 20 as shown in FIG. 2, and description of same or similar components are omitted herein.

As shown in FIG. 3, processor 30 may include the core 210 and the uncore 220, and the uncore 220 may include the first controller 100 and a second controller 200. The second controller 200 directly interacts with the controller 232 of the plurality of non-volatile memory modules 230 for data exchange.

The first controller 100 stores the first-type data to be stored into the target storage space. More specifically, the first controller 100 transmits the first-type data to be stored and the address information of the target storage space to the second controller 200, and the second controller 200 stores the first-type data to be stored in the target storage space.

The first controller 100 reads data from a first storage space. More specifically, the first controller 100 transmits the address information of the first storage space to the second controller 200, and receives from the second controller 200 the data read from the first storage space by the second controller 200.

That is, for the processor 30, the first controller 100 stores the first-type data to be stored into the target storage space through the second controller 200, and also reads data from the first storage space through the second controller 200, but does not directly perform data transmission with the persistent memories 236 of the non-volatile memory modules 230.

The present disclosure also provides a corresponding processing method for the processor having a core and an uncore, and the uncore includes a first controller and a second controller. The second controller directly performs data interactions with the controllers of the plurality of non-volatile memory modules.

The first controllers stores the first-type data to be stored to a target storage space. Specifically, the first controller transmits the first-type data to be stored and the address information of the target storage space to the second controller, and the controller stores the first-type data to be stored into the target storage space.

The first controller reads data from a first storage space. Specifically, the first controller sends the address information of the first storage space to the second controller, and receives from the second controller the data read by the second controller from the first storage space.

That is, the first controller does not directly perform data exchange with the persistent memories of the plurality of non-volatile memory modules, but achieves data exchange through the second controller. Thus, the structure design between the processor and the non-volatile memory modules can be simplified.

The second controller is further used for storing the second-type data transmitted by the core of the processor to the volatile memories of the plurality of non-volatile memory modules. The second controller may also be referred to as an internal memory controller (IMC). More specifically, the second controller may receive directly from the core of the processor second-type data to be stored, and second controller may store the to-be-stored second-type data in a volatile memory of the plurality of non-volatile memory modules, without going through the first controller.

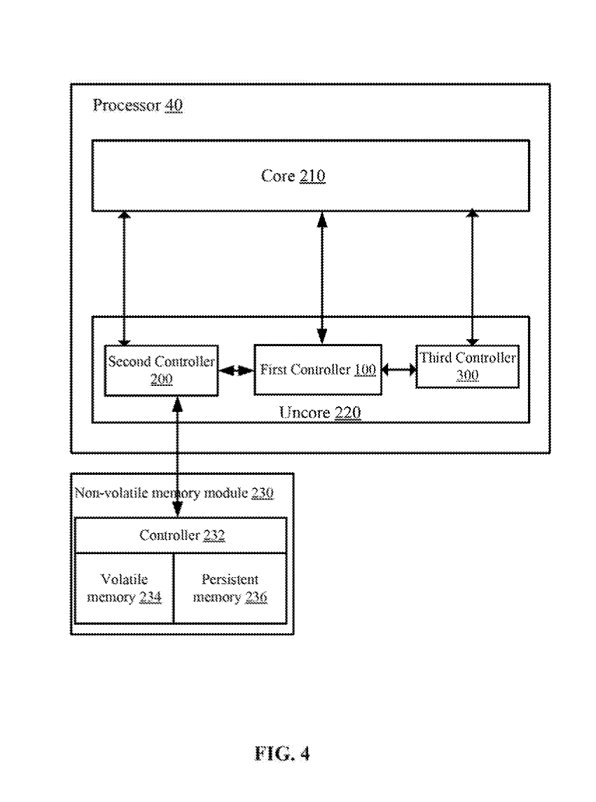

FIG. 4 illustrates a structural diagram of another exemplary processor 40 consistent with disclosed embodiments. Processor 40 as shown in FIG. 4 may be based on processor 30 as shown in FIG. 3, and description of same or similar components are omitted herein. As shown in FIG. 4, processor 40 may include the core 210 and the uncore 220, and the uncore 220 may include the first controller 100, a second controller 200, and a third controller 300. The processor 40 is connected to a plurality of external non-volatile memory modules.

The third controller 300 is provided for configuring the persistent memories 236 of the plurality of non-volatile memory modules 230 into a first disk array.

More specifically, the third controller 300 receives the first-type data to be stored transmitted by the core 210 of the processor 40, and stores the first-type data to be stored to the first disk array according to a preset storage rule. The third controller 300 receives from the core 210 of the processor 40 an instruction containing a data read request to read the first-type data. Based on the preset storage rule, the third controller 300 reads the data from the first disk array, and sends the read-back data to the core 210 of the processor 40.

When the third controller 300 stores the first-type data to be stored into the first disk array based on the preset storage rule, the first-type data to be stored is stored in the persistent memories 236 of the plurality of non-volatile memory modules 230. Specifically, the third controller 300 stores the first-type data in the persistent memories 236 of the plurality of non-volatile memory modules 230 sequentially through the first controller 100 and the second controller 200.

When the third controller 300 reads data from the first disk array according to the preset storage rule, data is read from the persistent memories 236 of the plurality of non-volatile memory modules 230. Specifically, sequentially through the first controller 100 and the second controller 200, the third controller 300 reads data from the persistent memories 236 of the plurality of non-volatile memory modules 230.

That is, under the processor 40, the third controller 300 can configure the persistent memories 236 of the plurality of non-volatile memory modules 230 as a first disk array. Accordingly, the third controller 300 can use existing disk array processing formats to perform data store and read operations on the persistent memories 236 of the plurality of non-volatile memory modules 230.

In certain implementation, the third controller 300 may be provided in the uncore 220 of processor 20 as shown in FIG. 2. In this case, the third controller 300 may directly perform data interaction with the persistent memory of the non-volatile memory modules.

In another embodiment, when the first controller 100 can directly interact with the persistent memory of the non-volatile memory modules, the third controller 300 may perform data interaction with the persistent memory of the non-volatile memory modules through the first controller 100.

The present disclosure also provides a corresponding processing method for the processor having a core and an uncore, and the uncore includes a first controller, a second controller, and a third controller. The third controller configures the persistent memories of the plurality of non-volatile memory modules externally connected to the processor into a first disk array. That is, logically, the third controller configures the persistent memories of the plurality of non-volatile memory modules into a first disk array. The disk array may be a redundant arrays of independent disks (RAID).

Further, the processing method may be based on the information processing method as shown in FIG. 1. On the basis of the information processing method shown in FIG. 1, the present processing method may also include the followings.

The third controller receives the first-type data to be stored sent by the core of the processor and stores the first-type data to be stored to the first disk array according to a preset storage rule.

The third controller receives a data read instruction sent by the core of the processor to read the first-type data, reads the data from the first disk array according to the preset storage rule, and sends the read-back data to the core of the processor.

Thus, according to the disclosed information processing method, the persistent memories of the plurality of non-volatile memory modules can be configured as a first disk array by the third controller. The third controller can then use existing processing formats for disk arrays to handle the data store and read operations on the persistent memories of the plurality of non-volatile memory modules.

It should be noted that, when the third controller stores the first-type data to be stored into the first disk array according to the preset storage rule, and reads the data from the first disk array according to the preset storage rule, the preset storage rule is determined by the mode of the first disk array. For example, there are many modes of RAID, such as RAID 0 mode, RAID 1 mode, RAID 0+1 mode, RAID 2 mode, RAID 3 mode, RAID 4 mode, and RAID 5 mode.

In one embodiment, the third controller may directly interact with the persistent memories of the plurality of non-volatile memory modules, which may lead to complex structure design between the processor and the non-volatile memory modules.

In another embodiment, the first controller interacts directly with the persistent memories of the plurality of non-volatile memory modules, and the third controller may interact with the persistent memories of the plurality of non-volatile memory modules through the first controller.

In another embodiment, the first controller interacts with the persistent memories of the plurality of non-volatile memory modules through the second controller, and the third controller may interact with the persistent memories of the plurality of non-volatile memory modules sequentially through the first controller and the second controller.

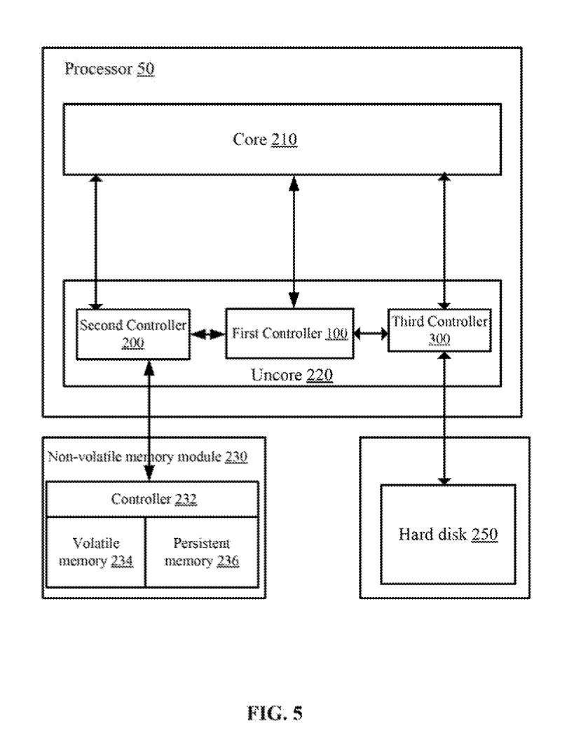

FIG. 5 illustrates a structural diagram of another exemplary processor 50 consistent with disclosed embodiments. Processor 50 as shown in FIG. 5 may be based on processor 40 as shown in FIG. 4, and description of same or similar components are omitted herein.

As shown in FIG. 5, processor 50 may include the core 210 and the uncore 220, and the uncore 220 may include the first controller 100, a second controller 200, and a third controller 300. The processor 50 is connected to a plurality of external non-volatile memory modules and a plurality of hard disks 250. A hard disk 250 may include a hard disk drive (HDD) or a solid state disk (SSD).

The third controller 300 is provided for configuring the persistent memories 236 of the plurality of non-volatile memory modules 230 and the plurality of hard disks 250 into a second disk array.

More specifically, the third controller 300 receives the first-type data to be stored transmitted by the core 210 of the processor 50, and stores the first-type data to be stored to the second disk array according to a preset storage rule. Further, the third controller 300 receives from the core 210 of the processor 50 an instruction containing a data read request to read the first-type data. Based on the preset storage rule, the third controller 300 reads the data from the second disk array, and sends the read-back data to the core 210 of the processor 50.

When the third controller 300 stores the first-type data to be stored into the second disk array based on the preset storage rule, the first-type data to be stored is stored in the persistent memories 236 of the plurality of non-volatile memory modules 230 and/or the plurality of hard disks 250. Specifically, the third controller 300 stores the first-type data in the persistent memories 236 of the plurality of non-volatile memory modules 230 through the first controller 100 and the second controller 200, sequentially, and/or in the plurality of hard disks 250.

When the third controller 300 reads data from the second disk array according to the preset storage rule, data is read from the persistent memories 236 of the plurality of non-volatile memory modules 230 and/or the plurality of hard disks 250. Specifically, the third controller 300 reads data from the persistent memories 236 of the plurality of non-volatile memory modules 230 sequentially through the first controller 100 and the second controller 200, and/or read data from the plurality of hard disks 250.

That is, for the processor 50, the third controller 300 can configure the persistent memories 236 of the plurality of non-volatile memory modules 230 and the plurality of hard disks 250 as a second disk array. Accordingly, the third controller 300 can use existing disk array processing format to perform data store and read operations on the persistent memories 236 of the plurality of non-volatile memory modules 230 and the plurality of hard disks 250.

In certain implementation, the third controller 300 may be provided in the uncore 220 of processor 20 as shown in FIG. 2. In this case, when the third controller 300 stores the first-type data to be stored into the second disk array based on the preset storage rule, the third controller 300 may directly perform data interaction with the persistent memory of the non-volatile memory modules and the plurality of hard disks 250.

In another embodiment, when the first controller 100 can directly interact with the persistent memory of the non-volatile memory modules, the third controller 300 may perform data interaction with the persistent memory of the non-volatile memory modules through the first controller 100.

It should be noted that, although only one non-volatile memory module and one hard disk are shown in FIG. 5, such configuration is used to merely illustrate the connection relationship between the non-volatile memory module and the processor, and the relationship between the hard disk and the processor. A plurality of non-volatile memory modules and hard disks may be included with similar connection relationships.

The present disclosure also provides a corresponding processing method for the processor having a core and an uncore, and the uncore includes a first controller, a second controller, and a third controller. The processor is connected to a plurality of non-volatile memory modules and multiple hard disks. The hard disks can be hard disk drives (HDD) or solid state drives (SSD). The third controller configures the persistent memories of the plurality of non-volatile memory modules and the multiple hard disks into a second disk array.

Further, the processing method may be based on the information processing method as shown in FIG. 1. On the basis of the information processing method shown in FIG. 1, the present processing method may also include the followings.

The third controller receives the first-type data to be stored sent by the core of the processor and stores the first-type data to be stored to the second disk array according to a preset storage rule.

The third controller receives a data read instruction sent by the core of the processor to read the first-type data, reads the data from the second disk array according to the preset storage rule, and sends the read-back data to the processor core.

Thus, according to the disclosed information processing method, the persistent memories of the plurality of non-volatile memory modules and multiple hard disks can be configured as a second disk array by the third controller. The third controller can then use existing processing formats for disk arrays to handle the data store and read operations on the persistent memories of the plurality of non-volatile memory modules and multiple hard disks.

It should be noted that, when the third controller stores the first-type data to be stored into the second disk array according to the preset storage rule, and reads the data from the second disk array according to the preset storage rule, the preset storage rule is determined by the mode of the second disk array.

In addition to interacting with the multiple hard disks, in one embodiment, the third controller may directly interact with the persistent memories of the plurality of non-volatile memory modules, which may lead to complex structure design between the processor and the non-volatile memory modules.

In another embodiment, the first controller interacts directly with the persistent memories of the plurality of non-volatile memory modules, and the third controller may interact with the persistent memories of the plurality of non-volatile memory modules through the first controller.

In another embodiment, the first controller interacts with the persistent memories of the plurality of non-volatile memory modules through the second controller, and the third controller may interact with the persistent memories of the plurality of non-volatile memory modules sequentially through the first controller and the second controller.

By using the disclosed processors and information processing methods, an uncore of a processor can be provided with a first controller, and the first controller can partition the persistent memories of the plurality of non-volatile memory modules into at least one storage unit. For the core of the processor to store the first-type data, the core of the processor only needs to send the first-type data to be stored and the identification of the target storage unit to the first controller. The first controller can then store the to-be-stored first-type data in the persistent memories of the plurality of non-volatile memory modules. For the core of the processor to read the first-type data, the core of the processor only needs to send to the first controller a data read request carrying an identification of the data to be read. The first controller can read the data to be read from the persistent memories of the plurality of non-volatile memory modules, and sends the read-back data to the core of the processor. Thus, the core of the processor does not need to directly manage persistent memories of the plurality external non-volatile memory modules, simplifying the data processing of the processor core.

Further, in the present disclosure, relational terms such as first, second, and the like, may be used solely to distinguish one entity or action from another entity or action without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element proceeded by “comprises . . . a” does not, without more constraints, preclude the existence of additional identical elements in the process, method, article, or apparatus that comprises the element.

Various embodiments of the present specification are described in a progressive manner, in which each embodiment focusing on aspects different from other embodiments, and the same and similar parts of each embodiment may be referred to each other. Because the disclosed devices correspond to the disclosed methods, the description of the disclosed devices and the description of the disclosed methods may be read in combination or in separation.

The description of the disclosed embodiments is provided to illustrate the present invention to those skilled in the art. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the principles and novel features disclosed herein.

What is claimed is:

1. An information processing method, comprising:
receiving, by a processor connected to a plurality of non-volatile memory modules, data to be stored and an identification of a target storage unit;
determining, by the processor, a target storage space from at least one of the plurality of non-volatile memory modules for storing the data; and
storing, by the processor, the data in the target storage space, and establishing an address mapping relationship between the identification of the target storage unit as received and the target storage space as determined.

2. The information processing method according to claim 1, further including:
receiving, by the processor, an instruction containing a data read request to read the data;
based on the address mapping relationship, determining, by the processor, the target storage space storing the data; and
reading, by the processor, the data from the target storage space.

3. The information processing method according to claim 1, wherein the processor comprises a core and an uncore coupled to the core, the uncore comprising a first controller for managing the plurality of non-volatile memory modules.

4. The information processing method according to claim 3, wherein:
the processor includes a second controller to manage the plurality of non-volatile memory modules, the second controller being coupled to the first controller,
storing the data in the target storage space includes:
transmitting, by the first controller, the data and the identification of the target storage unit to the second controller, and
storing, by the second controller, the data in the target storage space; and
reading the data from the target storage space includes:
transmitting, by the first controller, address information of the target storage space to the second controller, and
receiving, by the first controller, from the second controller the data from the target storage space.

5. The information processing method according to claim 4, further including:
receiving, by the second controller, the data to be stored; and
storing, by the second controller, the data in at least one of the plurality of non-volatile memory modules, without going through the first controller.

6. The information processing method according to claim 4, wherein the processor includes a third controller for configuring the plurality of non-volatile memory modules into a first disk array, and the information processing method further includes:
receiving, by the third controller, the data;
storing, by the third controller, the data in the first disk array based on a storage rule;
receiving, by the third controller, a data read instruction to read the data; and
reading, by the third controller, the data from the first disk array based on the storage rule.

7. The information processing method according to claim 6, wherein:
the data is stored to at least one of the plurality of non-volatile memory modules of the first disk array by the third controller via a sequential transmission of the data through the first controller and the second controller.

8. The information processing method according to claim 4, wherein the processor is further connected to multiple hard disks, and the processor further includes a third controller for configuring the plurality of non-volatile memory modules and the multiple hard disks into a second disk array, and the information processing method further includes:
receiving, by the third controller, the data;
storing, by the third controller, the data to the second disk array based on a storage rule;
receiving, by the third controller, a data read instruction to read the data; and
reading, by the third controller, the data from the second disk array based on the storage rule.

9. A processor, comprising:
a core for executing instructions; and
a first controller coupled to the core and a plurality of non-volatile memory modules,
wherein the first controller is configured to:
receive data to be stored and an identification of a target storage unit;
determine a target storage space from at least one of the plurality of non-volatile memory modules for storing the data; and
store the data in the target storage space, and establish an address mapping relationship between the identification of the target storage unit as received and the target storage space as determined.

10. The processor according to claim 9, wherein the first controller is further configured to:
receive from the core an instruction containing a data read request to read the data;
based on the address mapping relationship, determine the target storage space storing the data; and
read the data from the target storage space.

11. The processor according to claim 9, further comprising:
a second controller coupled to the first controller and the plurality of non-volatile memory modules, the second controller being for managing the plurality of non-volatile memory modules, wherein;
to store the data in the target storage space includes:
to transmit, by the first controller, the data and the identification of the target storage unit to the second controller, and
to store, by the second controller, the data in the target storage space; and
to read the data from the target storage space includes:
to transmit, by the first controller, address information of the target storage space to the second controller, and
to receive, by the first controller, from the second controller the data as read from the target storage space by the second controller.

12. The processor according to claim 1, wherein the second controller is further configured to:
receive the data directly from the core; and
store the data in at least one of the plurality of non-volatile memory modules, without going through the first controller.

13. The processor according to claim 11, further comprising a third controller, wherein the third controller:
configures the plurality of non-volatile memory modules into a first disk array;
receives the data from the core;
stores the data to the first disk array based on a storage rule;
receives a data read instruction from the core to read the data; and
reads the data from the first disk array based on the storage rule.

14. The processor according to claim 13, wherein:
the third controller stores the data to at least one of the plurality of non-volatile memory modules of the first disk array via a sequential transmission of the data through the first controller and second controller.

15. The processor according to claim 13, wherein the first disk array is a redundant array of independent disks (RAID).

16. The processor according to claim 11, wherein:
the first controller is a persistent memory manager (PMM); and
the second controller is an internal memory controller (IMC).

17. The processor according to claim 11, wherein the processor is further connected to multiple hard disks, and the processor further includes a third controller, wherein the third controller:
configures the plurality of non-volatile memory modules and the multiple hard disks into a second disk array;
receives the data from the core;
stores the data to the second disk array based on a storage rule;
receives a data read instruction from the core to read the data; and
reads the data from the second disk array based on the storage rule.
